(19) United States
(12) Patent Application Publication
(10) Pub. No.: US 2024/0355502 A1
(43) Pub. Date: Oct. 24, 2024

(54) CONTAINER FOR STORING AND TRANSPORTING A DIELECTRIC INSULATION MEDIUM

(71) Applicant: Hitachi Energy Ltd, Zürich (CH)

(72) Inventors: Michael GATZSCHE, Zürich (CH); Johannes HENGSTLER, Lufingen (CH); Max-Steffen CLAESSENS, Untersiggenthal (CH); Manuel NAEF, Rapperswil-Jona (CH); Matteo CALAMARI, Vigolzone, Piacenza (IT)

(21) Appl. No.: 18/579,182

(22) PCT Filed: Jul. 12, 2022
(86) PCT No.: PCT/EP2022/069497

§ 371 Date: Jan. 12, 2024

(30) Foreign Application Priority Data
Jul. 13, 2021 (EP) 21185439.3

(51) Int. Cl. H01B 3/56; F17C 7/00; F17C 13/02

(52) U.S. Cl. CPC H01B 3/56; F17C 7/00; F17C 13/026; F17C 2221/03; F17C 2250/0439

(57) ABSTRACT

A container for storing and transporting a dielectric insulation medium, including:
a container interior for containing the dielectric insulation medium, and connecting means for connecting the container to an electrical apparatus of medium or high voltage and filling a housing of the electrical apparatus with the dielectric insulation medium, said dielectric insulation medium being a mixture of
an organofluorine compound or a mixture of organofluorine compounds as component A, the molar percentage of component A being in a range from 1 to 15 mol %, and
a carrier gas compound or a mixture of carrier gas compounds other than an organofluorine compound as component B.

The component B may include nitrogen, the molar percentage of nitrogen in the dielectric insulation medium being at least 65 mol %, and the minimum storage and transportation temperature of the container is equal or higher than the cricondentherm of the insulation medium.

### CROSS REFERENCE TO RELATED APPLICATIONS

This application is a 35 U.S.C. § 371 national stage application of PCT International Application No. PCT/EP2022/069497 filed on Jul. 12, 2022, which in turn claims foreign priority to European Patent Application No. 21185439.3, filed on Jul. 13, 2021, the disclosures and content of which are incorporated by reference herein in their entirety.

### FIELD OF THE DISCLOSURE

The present disclosure relates to a container for storing and transporting a dielectric insulation medium, and to a method of filling a housing of an electrical apparatus of medium or high voltage with a dielectric insulation medium.

### BACKGROUND

Electrical apparatuses of medium or high voltage are typically filled with a dielectric insulation medium in gaseous or liquid state.

In medium or high voltage metal-encapsulated switchgears, for example, the electrically conductive part is arranged in a gas-tight housing, which defines an insulating space filled with in an insulation gas separating the housing from the electrically conductive part without letting electrical current to pass through the insulation space. For interrupting the current in e.g. high voltage switchgears, the insulating gas further functions as an arc-extinction gas.

Sulphur hexafluoride (SF₆) is a well-established insulation gas due to its outstanding dielectric properties and its chemical inertness. Despite these properties, efforts to look for an alternative insulation gas have nevertheless been intensified, in particular in view of a substitute having a lower Global Warming Potential (GWP) than the one of SF₆.

In view of providing a non-SF₆ substitute, the use of organofluorine compounds in dielectric insulation media has been suggested.

Fluoroketones have been shown to have a high dielectric strength. At the same time, they have a very low Global Warming Potential (GWP) and very low toxicity. Owed to the combination of these characteristics, fluoroketones constitute a viable alternative to SF₆.

Given the relatively high boiling point of these compounds, they are typically used in a mixture with a carrier gas component (also referred to as “background gas” component) of a lower boiling point, thus allowing a relatively high gas density (and thus a sufficient dielectric strength) to be obtained.

In the past, the filling of the housing of an electrical apparatus with insulation gas mixtures has turned out to be complex.

According to a first approach, the components of the mixture are added to the housing from two separate containers. The drawback of this approach is that it requires two separate containers to be manipulated. In addition, the mixture created in the housing is not immediately homogenous and requires time until homogenization is established and the apparatus is ready for operation.

According to a second approach, a gas mixture is provided prior to the filling. The drawback of this approach is that it requires relatively complex and expensive gas mixing devices, which have to guarantee that the gas mixture obtained is homogenous and that the ratio of the components contained in the mixture is accurate. This is particularly disadvantageous from the point of view that the site of filling is typically remote from the site of producing the containers containing the individual components.

According to a third approach, the filling starts from a liquefied mixture and uses either the liquid or the gaseous phase for filling.

This approach has the drawback that the ratio of the components in the gaseous and the liquid phase changes with the filling rate of the container, owed to the fact that the components typically have a different boiling point.

### SUMMARY

In consideration of the above, it would be desirable to provide a system, which when using an insulation medium containing an organofluorine compound allows a homogenized mixture to be instantly established in the housing without requiring devices for gas mixing and heating.

The problem to be solved can thus be seen in providing a container for storing and transporting the insulation medium, allowing the filling of the housing of an electrical apparatus in a manner that a homogenized gas mixture is instantly established in the housing without requiring devices for gas mixing and heating and which results in a dielectric strength in the housing sufficient for the apparatus to fulfil its dielectric ratings. In addition, a respective method for filling the housing of an electrical apparatus of medium or high voltage shall be provided.

According to an embodiment, the container of the present disclosure comprises: a container interior, in which the dielectric insulation medium is contained, and connecting means for connecting the container to an electrical apparatus of medium or high voltage and filling a housing of the electrical apparatus with the dielectric insulation medium.

Specifically, the dielectric insulation medium contained in the container of the present disclosure is a mixture of
A) an organofluorine compound or a mixture of organofluorine compounds as component A, the molar percentage of component A in the dielectric insulation medium being in a range from 1 to 15 mol %, and
B) a carrier gas compound or a mixture of carrier gas compounds other than an organofluorine compound as component B.

According to the disclosure, the component B comprises nitrogen, the molar percentage of nitrogen in the dielectric insulation medium being at least 65 mol %.

### BRIEF DESCRIPTION OF THE DRAWINGS

The concept of the present disclosure is further illustrated by way of the following working examples in combination with the figures, of which

FIG. 1 shows the cricondentherm of a first dielectric insulation medium containing C4-FN, nitrogen and oxygen in dependence on the molar ratio of C4-FN; and

FIG. 2 shows the cricondentherm of a second dielectric insulation medium containing C5-FK, nitrogen and oxygen in dependence on the molar ratio of C5-FK.

### DETAILED DESCRIPTION

For specific mixtures according to the present disclosure, a cricondentherm effect has been observed, meaning that at a temperature above the so-called cricondentherm, no condensation takes place irrespective of the pressure applied. In other words, the dielectric insulation medium can be stored in the container in fully gaseous state irrespective of the pressure applied, and sophisticated heating means required for insulation media or insulation medium components stored in liquid state for bringing them in gaseous form prior to the filling can be omitted.

The effect is particularly pronounced if the boiling point of the at least one compound of component A is at least −75° C., such as at least −50° C., at least −25°° C., and/or in a range from −10°° C. to 30° C.

According to the disclosure, the minimum storage and transportation temperature of the container is equal or higher than the cricondentherm of the insulation medium, such as at least 5 K higher than the cricondentherm. Above the cricondentherm, the mixture is in gaseous phase even at very high pressures, and, owed to the specific molar percentage of the organofluorine compound and to the high molar percentage of nitrogen used, this effect is achieved at relatively low temperatures of use. In other words, embodiments of the disclosure may guarantee that the mixture is permanently in fully homogenous gaseous form and therefore ready to be used for filling, without requiring any gas mixing or gas heating steps prior to the filling.

According to a specific embodiment, the dielectric insulation medium contained in the container is thus permanently in fully homogenous gaseous form, and more specifically is in fully homogenous gaseous form if pressurized, in particular to at least 20 bar, as will be discussed further down below. This is in clear contrast to the prior art devices, which may require sophisticated equipment for heating the insulating medium to a temperature above the critical temperature prior to filling it into the electrical apparatus.

For example, a mixture comprising 4 mol % of heptafluoroisobutyronitrile as component A and 91 mol % of nitrogen as well as 5 mol % of oxygen as component B has been found not to show any condensation down to temperature of −20° C., even if the pressure set in the container is 100 bar or above. Thus, the container allows a highly compressed gas mixture to be stored and transported, and the need for large storage space and complex transportation vehicles can thus be mitigated. In particular, the container containing a relatively high amount of insulation gas can be stored at the site of the end consumer even in very cold areas and independent of the season, and is ready for use immediately once filling is required, which is of particular relevance in case of an emergency (top-up) filling of the device.

In addition, it has been found that this mixture does not show any condensation in the housing of the electrical apparatus down to the minimum operating temperature of −30° C., even if the filling pressure set in the housing is 10 bar. Due to the fact that in essence all of the insulation gas mixture is in gaseous state and due to the fact that especially the dielectric compound is in essence all in gaseous state, it is therefore ensured that a relatively high, sufficient dielectric strength is achieved in the housing over the full range of operating temperatures.

Ultimately, the container of the present disclosure thus allows the housing to be filled in a relatively simple manner without requiring complex equipment. Due to the relatively low temperature permitted, also storage and transport of the container is easy and does not require sophisticated means. Since the mixture contained in the container is homogenous, the composition remains constant even after several filling operations and even in case unwanted leakage of the insulation medium occurs. Thus, the present disclosure circumvents the disadvantages discussed above in the context of the filling approach starting from a liquefied mixture and using either the liquid or the gaseous phase for filling.

As mentioned above, the insulation medium mixture contained in the inner volume may be in compressed state. In particular, the filling pressure in the container interior may be at least 20 bar, at least 50 bar, at least 70 bar and/or at least 100 bar. Owed to the fact that also at these high filling pressures no condensation occurs, very high amounts of insulation gas can be stored without the need for large storage space, as mentioned above.

To guarantee that the minimum storage and transportation temperature is constantly complied with, the container can be provided with a temperature indicator, in particular a signaling device for signaling an internal temperature below a predefined threshold value.

As will be shown by way of the working examples, the minimum storage and transportation temperature of the container is dependent on the molar percentage of the organofluorine compound and can vary between different organofluorine compounds.

Within the range set by the formula defined in the working examples, the specific concentration of component A can be chosen depending on the minimum storage and transportation temperature of the container or depending on the rated gas pressure of the apparatus.

If for example the minimum storage and transportation temperature is relatively low, a lower concentration of compound A is to be chosen to safeguard that no condensation occurs. On the other hand, a higher concentration of compound A can be chosen for a higher minimum storage and transportation temperature.

If the rating of the apparatus allows a relatively high filling pressure and therefore a high gas density, the concentration of the organofluorine compound, i.e. the primary dielectric compound, can be relatively low, allowing the mixture to be used for a container of a relatively low minimum storage and transportation temperature, and vice versa.

Depending on the choice of the specific component A, in can be desirable that the lower limit of the molar percentage of component A may be set at about 2 mol %, and/or about 3 mol %, safeguarding a high dielectric strength in the electrical apparatus, into which the dielectric insulation medium is to be filled. Depending on the specific component A used, it can further be desirable that the upper limit of the molar percentage of component A may be set at about 14 mol %, about 12 mol %, and/or about 11 mol %, which may guarantee that irrespective of the pressure applied in the container interior, no condensation occurs even at relatively low temperatures.

In particular in view of using heptafluoroisobutyronitrile, which is one of the organofluorine compounds discussed in the working examples, it has been found that the insulation medium mixture remains fully gaseous even up to a molar percentage of as high as 12 mol %, if the storage and transportation temperature does not fall below 10° C.

According to an embodiment of the disclosure, the molar percentage of nitrogen in the insulation medium may be at least 70 mol %, at least 75 mol %, and/or at least 80 mol %, further improving the cricondentherm effect in a manner that the minimum storage and transportation temperature at which no condensation occurs can be set even lower.

A particularly pronounced cricondentherm effect is achieved for a mixture in which component A is selected from the group consisting of fluoroethers, in particular hydrofluoromonoethers, fluoroketones, in particular perfluoroketones, fluoroolefins, in particular hydrofluoroolefins, and fluoronitriles, in particular perfluoronitriles, and mixtures thereof, and in particular is a perfluoroketone and/or a perfluoronitrile.

More particularly, component A comprises or essentially consists of heptafluoroisobutyronitrile and/or of 1,1,1,3,4,4,4-heptafluoro-3-(trifluoromethyl)-butan-2-one, the cricondentherm effect of this embodiment and its technical relevance being explained in further detail by way of the working examples discussed further down below.

For a first specific embodiment, in which component A comprises or essentially consists of heptafluoroisobutyronitrile (in the following also referred to as “C4-FN”), the molar percentage of component A may be in range from 2 to 15 mol %, from 3 to 14 mol %, and/or from 3 to 12 mol %.

According to a more specific variant of the first embodiment mentioned above, the dielectric insulation medium comprises an amount of 4 mol % of C4-FN as component A, and a mixture of N₂ and O₂ as component B in in an amount of 96 mol %. This dielectric insulation medium shows no condensation at a temperature of −20° C. or higher and can therefore be used for a container subject to a minimum ambient temperature of −20° C. Despite its relatively low content of the organofluorine compound C4-FN, sufficient dielectric strength can be obtained in an apparatus of a rated filling pressure of 13 bar (abs @20° C.) and a minimum operating temperature of −30° C.

According to another specific variant of the first embodiment mentioned above, the dielectric insulation medium comprises an amount of 6 mol % of C4-FN as component A and an amount of 94 mol % of component B, again being a mixture of N₂ and O₂. This dielectric insulation medium shows no condensation at a temperature of −10° C. or higher independent on the filling pressure in the container and allows sufficient dielectric strength to be obtained in an apparatus of a rated filling pressure of 8 bar (abs @20° C.) and a minimum operating temperature of −30° C.

According to still further specific variant of the first embodiment mentioned above, the dielectric insulation medium comprises an amount of 10 mol % of C4-FN as component A and an amount of 90 mol % of component B, again being a mixture of N₂ and O₂. For an apparatus of a rated filling pressure of 6 bar (abs @20° C.) and a minimum operating temperature of −25° C., sufficient dielectric strength can still be obtained by using this insulation medium, and no condensation occurs in the container at a temperature of 5° C. or higher.

For a second specific embodiment, in which component A comprises or essentially consists of 1,1,1,3,4,4,4-heptafluoro-3-(trifluoromethyl)-butan-2-one (in the following also referred to as “C5-FK”), the molar percentage of component A may be in range from 1 to 14 mol %, from 1 to 9 mol %, from 1 to 5 mol %, and/or from 1 to 3 mol %.

For some embodiments, component B may comprise an oxidizing gas, such as oxygen, for preventing the formation of soot, in particular in the course of a switching operation in which the dielectric insulation gas has the further function of an arc-extinction medium. In this regard, it may be desirable that the molar percentage of oxidizing gas in the insulation medium may be in a range from 1 to 21 mol %, from 2 to 15%, and/or from 3 to 11%.

According to a further embodiment, the molar percentage of carbon dioxide in the insulation medium may be lower than 10 mol %, lower than 5 mol %, and/or lower than 2 mol %. In some examples, the alternative insulation medium is at least approximately devoid of carbon dioxide.

According to a further aspect, the present disclosure also relates to a method of filling a housing of an electrical apparatus of medium or high voltage with a dielectric insulation medium, the method comprising the steps of
providing a container as defined above, in which the dielectric insulation medium is stored and transported;
connecting the connecting means of the container to the housing;
establishing a fluid channel between the container and the housing allowing the insulation medium to flow from the
container interior into the housing to fill the housing; and closing the fluid channel and detaching the connecting means of the container from the housing,
wherein during the method the container is maintained at a temperature above the cricondentherm of the insulation medium contained in the container, such as at least 5 K above the cricondentherm of the insulation medium contained in the container.

In order to safeguard that no condensation occurs during filling of the housing, it can be desirable that the container, in particular the connecting means and/or the fluid channel, is provided with heating means designed for maintaining the temperature of the insulation medium above the cricondentherm of the insulation medium, such as at least 5 K above the cricondentherm of the insulation medium contained in the container. Thus, potential problems arising from the decompression of the gas and the temperature drop owed to the Joule-Thomson effect can be efficiently circumvented, which is of particular relevance when using a container having a high filling pressure of 100 bar or more.

Additionally or alternatively, it can be desirable that the connecting means and/or the fluid channel are provided with a pressure regulator for regulating the pressure of the insulation medium during filling of the housing. Thus, decompression can be carried out in a controlled manner, further mitigating the risk of a temperature drop and an unwanted condensation of the dielectric insulation medium.

In particular, a heated pressure regulator as known to the skilled person can be used. An example of a heated pressure regulator is available from Swagelok Co. (Solon, USA).

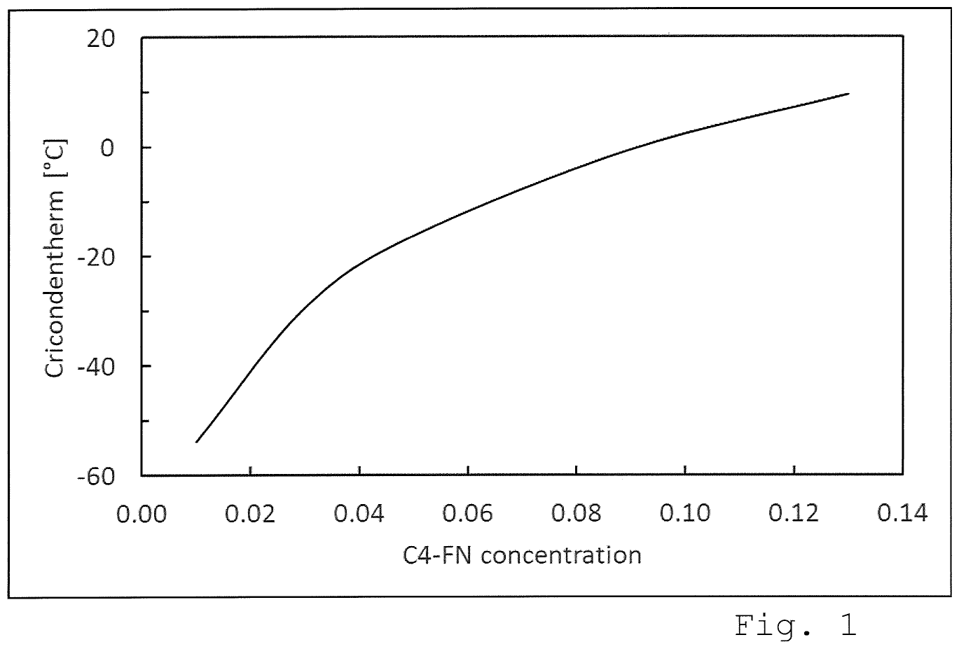

Specifically, FIG. 1 refers to a tertiary dielectric insulation medium containing C4-FN in varying amounts ranging from 1 to 13 mol %, oxygen in an amount of 5 mol %, and the remainder being nitrogen.

As pointed out above, the minimum storage and transportation temperature of the container may be 5 K above the cricondentherm, which ensures that the mixture is in gaseous phase even at very high pressures. As shown in FIG. 1, the cricondentherm for a mixture containing 9 mol % of C4-FN is about 0° C. and is less than −20° C. for a mixture containing 4 mol % C4-FN. This is taken into account when setting the minimum storage and transportation temperature of the container containing the medium to lie at least about 5 K above the cricondtherm. In other words, a dielectric insulation gas containing 4 mol % C4-FN does not show any condensation at above −15° C. irrespective of the filling pressure applied in the container, as it lies (5 K) above the cricondentherm. Under the condition that the temperature is always at least −15° C., it therefore allows very high filling pressures and a space-saving storage without any condensation of the medium contained.

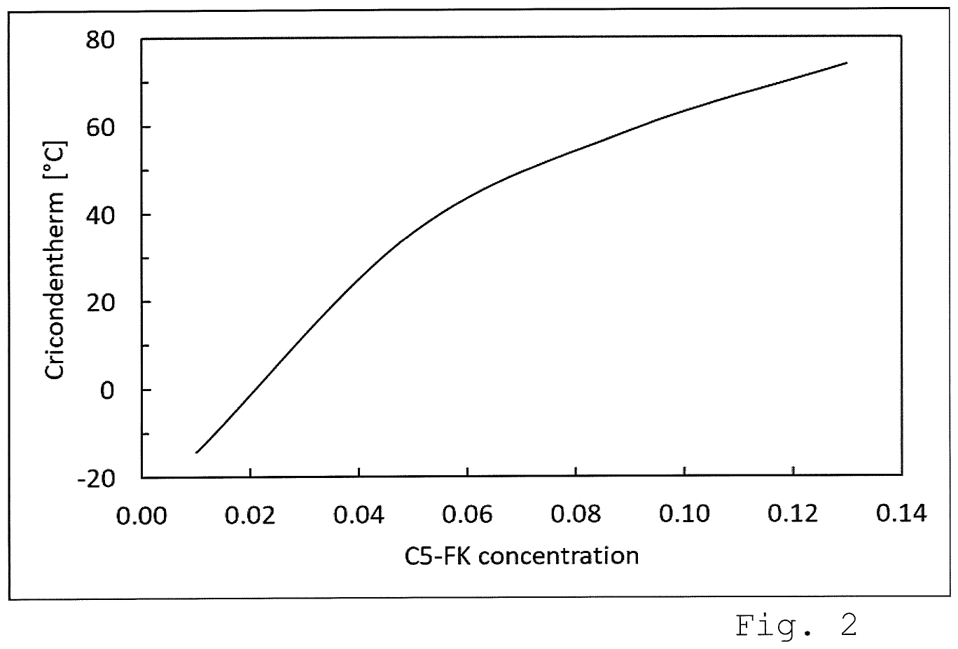

The specific dielectric insulation medium referred to in FIG. 2 is a tertiary dielectric insulation medium containing C5-FK in varying amounts ranging from 1 to 13 mol %, oxygen in an amount of 5 mol %, and the remainder being nitrogen.

Based on the cricondentherm shown in FIG. 2, the minimum storage and transportation temperature of the container containing this second dielectric insulation medium can be derived in analogy to what has been explained above for the first dielectric insulation medium. Also for the second dielectric insulation medium, the minimum storage and transportation temperature of the container containing the medium is set to lie at least about 5 K above the cricondtherm.

At I_{min.stor,C4FN} and T_{min.stor,C5FK}, respectively, the insulation medium is in the embodiments referred to above in purely gaseous form, independent on the filling pressure of the container.

The disclosure also encompasses a dielectric insulation medium being a gas mixture of SF₆ and a carrier gas, in particular nitrogen, the molar percentage of the carrier gas being set such that a cricondentherm effect is achieved.

1.-16. (canceled)

17. A container for storing and transporting a dielectric insulation medium, the container comprising:
a container interior, in which the dielectric insulation medium is contained, and
connecting means for connecting the container to an electrical apparatus of medium or high voltage and for filling a housing of the electrical apparatus with the dielectric insulation medium,
said dielectric insulation medium being a mixture of:
an organofluorine compound or a mixture of organofluorine compounds as component A, the molar percentage of component A in the dielectric insulation medium being in a range from 1 to 15 mol %, and
a carrier gas component or a mixture of carrier gas components other than an organofluorine compound as component B,
component A being a perfluoroketone and/or a perfluoronitrile and the component B comprising nitrogen, the molar percentage of nitrogen in the dielectric insulation medium being at least 65 mol %, and
the container being provided with a temperature indicator allowing that the minimum storage and transportation temperature of the container is equal or higher than the cricondentherm of the insulation medium.

18. Container according to claim 17, wherein the boiling point of the at least one compound of component A is at least 75° C.

19. Container according to claim 17, wherein the boiling point of the at least one compound of component A is in a range from 10° C. to 30° C.

20. Container according to claim 17, wherein the minimum storage and transportation temperature of the container is at least 5 K higher than the cricondentherm.

21. Container according to claim 17, wherein the molar percentage of nitrogen in the insulation medium is at least 70 mol %.

22. Container according to claim 17, wherein component A comprises heptafluoroisobutyronitrile and/or of 1,1,1,3,4,4,4-heptafluoro-3-(trifluoromethyl)-butan-2-one.

23. Container according to claim 22, wherein component A comprises heptafluoroisobutyronitrile, the molar percentage of component A being in range from 2 to 15 mol %.

24. Container according to claim 22, wherein component A comprises 1,1,1,3,4,4,4-heptafluoro-3-(trifluoromethyl)-butan-2-one, the molar percentage of component A being in range from 1 to 14 mol %.

25. Container according to claim 17, wherein component B further contains an oxidizing gas.

26. Container according to claim 25, wherein the molar percentage of oxidizing gas in the insulation medium is in a range from 1 to 21 mol %.

27. Container according to claim 17, wherein the molar percentage of carbon dioxide in the insulation medium is lower than 10 mol %.

28. Container according to claim 17, wherein the filling pressure in the container interior is at least 20 bar.

29. Container according to claim 17, wherein the temperature indicator is a signaling device for signaling an internal temperature below a predefined threshold value.

30. Use of container for storing and transporting a dielectric insulation medium, the container comprising:
a container interior, in which the dielectric insulation medium is contained, and
connecting means for connecting the container to an electrical apparatus of medium or high voltage and for filling a housing of the electrical apparatus with the dielectric insulation medium,
said dielectric insulation medium being a mixture of:
an organofluorine compound or a mixture of organofluorine compounds as component A, the molar percentage of component A in the dielectric insulation medium being in a range from 1 to 15 mol %, and
a carrier gas component or a mixture of carrier gas components other than an organofluorine compound as component B,
wherein component A is a perfluoroketone and/or a perfluoronitrile and the component B comprises nitrogen, the molar percentage of nitrogen in the dielectric insulation medium being at least 65 mol %, and
the minimum storage and transportation temperature of the container is equal or higher than the cricondentherm of the insulation medium.

31. A method of filling a housing of an electrical apparatus of medium or high voltage with a dielectric insulation medium, the method comprising the steps of
providing a container as defined in claim 30, in which the dielectric insulation medium is stored and transported;
connecting the connecting means of the container to the housing;
establishing a fluid channel between the container and the housing allowing the insulation medium to flow from the container interior into the housing to fill the housing; and
closing the fluid channel and detaching the connecting means of the container from the housing,
wherein during the method the container is maintained at a temperature above the cricondentherm of the insulation medium contained in the container, preferably at least 5 K above the cricondentherm of the insulation medium contained in the container.

32. Method according to claim 31, wherein the container, in particular the connecting means and/or the fluid channel, is provided with heating means designed for maintaining the temperature of the insulation medium above the cricondentherm of the insulation medium contained in the container.

33. Method according to claim 31, wherein the connecting means and/or the fluid channel are provided with a pressure regulator for regulating the pressure of the insulation medium during filling of the housing.
